(19) United States
(12) Patent Application Publication
(10) Pub. No.: US 2008/0184500 A1
(43) Pub. Date: Aug. 7, 2008

(54) Bi-Fold Wheelchair Ramp

(75) Inventor: Robert E. Bettcher, Terre Haute, IN (US)

Correspondence Address: MICHAEL BEST & FRIEDRICH LLP, Two Prudential Plaza, 180 North Stetson Avenue, Suite 2000, CHICAGO, IL, 60601, US

(73) Assignee: THE BRAUN CORPORATION, Winamac, IN (US)

(21) Appl. No.: 11/574,958

(22) PCT Filed: Sep. 2, 2005
(86) PCT No.: PCT/US05/31584

§ 371 Date: Mar. 8, 2007

Related U.S. Application Data
(60) Provisional application No. 60/608,611, filed on Sep. 10, 2004.

(51) Int. Cl. B60P 1/00

(52) U.S. Cl. 14/71.1

(57) ABSTRACT

A dynamic system for folding and unfolding of one ramp section of a bi-folding, flip-out wheelchair ramp relative to the orientation of a driven ramp section is provided. The ramp section coupled to the dynamic system generally moves under the force of gravity during stowage and deployment. The dynamic system is independent from the drive system of the ramp and opposes the force of gravity. One embodiment of the dynamic system includes a fixed length cable connecting the non-driven ramp section to the enclosure, a gas spring for tensioning the cable and a pulley arrangement.

### RELATED APPLICATIONS

This invention claims priority to Provisional Application 60/608,611 filed on Sep. 10, 2004.

### FIELD OF THE INVENTION

The invention relates to ramp systems, and more particularly the present invention relates to a bi-fold wheelchair ramp for a vehicle.

### BACKGROUND OF THE INVENTION

Wheelchair ramp systems for vehicles are well known, and have been employed to enable persons who are physically challenged or otherwise have limited mobility to board and leave a vehicle. Various wheelchair ramp systems have been proposed that include electrical, pneumatic, or hydraulic drive systems. Recently, hydraulic-driven wheelchair ramp systems have become more prevalent due to their durability, reliability, and cost. Bi-fold ramps in particular are gaining popularity for vehicle use due to their extended length, and therefore less severe angle of inclination, that facilitates entry into the vehicle for passengers using manual wheelchairs. However, known wheelchair ramp systems are unduly complicated having hydraulic systems that require electrical switching of solenoid valves or mechanical drive systems with linkage assemblies. Therefore, in view of the foregoing a new bi-fold wheelchair ramp with improved hydraulic and mechanical drive systems would be welcomed.

### SUMMARY OF THE INVENTION

One embodiment provides a drive system for reversibly moving one section of a bi-folding, flip-out wheelchair ramp. The second ramp section generally moves under the force of gravity during stowage. A dynamic system that is independent from the drive system opposes the force of gravity on the second ramp section during folding and unfolding of the second ramp section relative to the orientation of the driven ramp section. The two folding ramp sections are hingedly coupled to each other and the first ramp section is hingedly coupled to a mounting enclosure located within the vehicle threshold. When stowed, the ramp sections fold substantially flat upon themselves on top of the mounting enclosure in the threshold. When fully deployed, the ramp sections unfold to form a continuous coplanar ramp. One embodiment of the dynamic system includes a cable connecting the second ramp section to the enclosure, a gas spring for tensioning the cable and a pulley arrangement.

### BRIEF DESCRIPTION OF THE DRAWINGS

The present invention is described with reference to the accompanying figures which illustrate embodiments of the present invention. However, it should be noted that the invention as disclosed in the accompanying figures and appendices is illustrated by way of example only.

FIG. 1 is a perspective view of an exemplary bi-fold ramp in a fully deployed state with the cover for the mounting enclosure removed;

FIG. 2 is a perspective view of the exemplary bi-fold ramp of FIG. 1 in a fully stowed state;

FIGS. 3-10 illustrate the cable and pulley components of the exemplary bi-fold ramp of FIG. 1; and

FIGS. 11-18 illustrate perspective views of the exemplary bi-fold ramp of FIG. 1 in various intermediate states between the fully deployed state of FIG. 1 and the fully stowed state of FIG. 2.

### DETAILED DESCRIPTION OF THE EMBODIMENTS

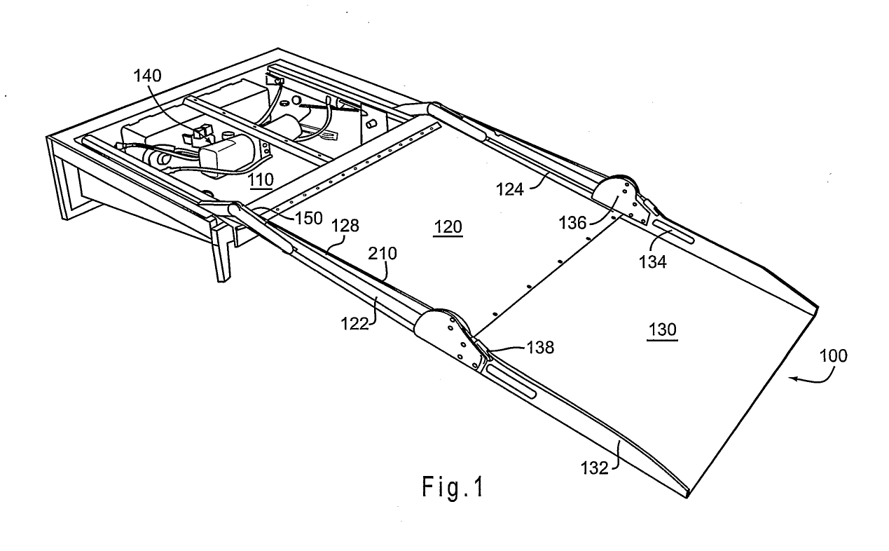

Referring now to FIG. 1 a bi-fold wheelchair ramp for a vehicle is shown. For ease of reference, the modifier “inboard” shall refer to a direction toward a vehicle in which the bi-fold ramp is installed or inward, whereas the modifier “outboard” shall refer to a direction away from the vehicle or outward. As can be appreciated from FIG. 1, many components of the system 100 are duplicated or otherwise arranged generally symmetrically about a vertical plane of symmetry. This plane is referred to herein as the centerline (C/L) of the system 100. For simplicity of explanation, one side of the system 100 will be described herein, but corresponding parts or elements on each side of the centerline may be referred to by the same reference number and distinguished by the “prime” symbol when required.

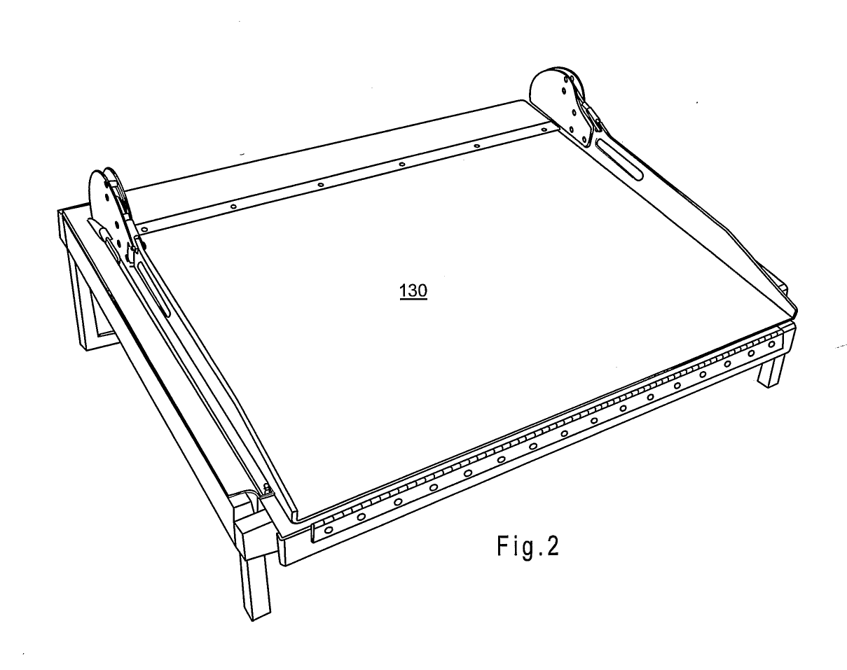

As shown in FIG. 1, the ramp system 100 includes a mounting enclosure 110 that is installed within the floor of a vehicle's threshold for housing the ramp system drive components. A ramp with an inboard ramp section 120 is coupled to the outboard edge of the enclosure 110 (e.g., as illustrated, section 120 is hingedly coupled to enclosure 110). An outboard ramp section 130 coupled to the outboard edge of the inboard ramp section 120. The cover (not shown) for the mounting enclosure 110 has been removed in FIG. 1 to show the general arrangement of components of the system 100. In operation, the ramp system 100 is deployed from and folded to a stowed state shown in FIG. 2 where the ramp sections 120, 130 are folded substantially flat on top of the enclosure 110. When the system 100 is operated, the ramp sections 120, 130 are deployed to a coplanar and inclined orientation with respect to the enclosure 110 so that persons who are physically challenged or otherwise have limited mobility may board and leave a vehicle such as a minivan, van, bus, or other structure such as a doorway or loading dock of a building. Such a ramp system 100 is not limited to wheelchairs, but may be used to provide vehicle access for carts or wheeled containers for transport by way of a vehicle.

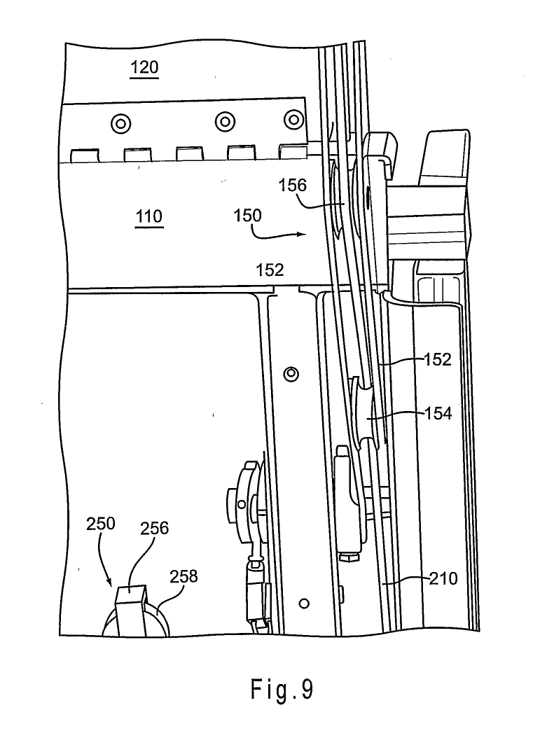

The mounting enclosure 110 includes a pan that is recessed into the vehicle floor and a cover plate (not shown) that is removable so that the ramp's drive system components within the enclosure 110 may be serviced, maintained or the like. By fully enclosing the drive system as shown, the ramp system 100 is substantially self contained and may be installed as a “drop-in” system. Additionally, by fully enclosing the drive system only power connections to the ramp system 100 may be required. As can be appreciated from FIG. 1, the drive system 140 is a hydraulic-actuated linear drive, but the drive system 140 may be electrical, pneumatic, rotary or another type of drive known in the art. An exemplary hydraulic drive system includes a bi-directional hydraulic power unit that drives hydraulic cylinders having gear racks attached to the cylinders' movable rod ends for rotating a spur gear to pivot a drive member. As shown, the drive system 140 may include a pair of drive members 150 that couple with each side of the inboard ramp section 120. As is known, the drive member 150 pivots, rotates or otherwise moves into and out from the enclosure 110 to stow and deploy the ramp, respectively. As best illustrated in FIG. 9, the drive member 150 is connected to the drive system 140 (in FIG. 1) at the drive member's inboard end and has two side plates 152, 152′ spaced apart by guides 154, 156. The first guide 154 is affixed to the plates 152, 152′ proximate the drive member’s inboard end and the second guide 156 is affixed to the plates 152, 152′ at a position intermediate to the drive member's inboard and outboard ends. As shown in FIG. 1, the plates 152, 152′ may be formed or bent at the second guide 156 so that the drive member 150 makes an obtuse angle. The drive member 150 operates to rotate the inboard ramp section 120 more than one hundred eighty degrees and does not extend from the enclosure 110 when the ramp is fully stowed.

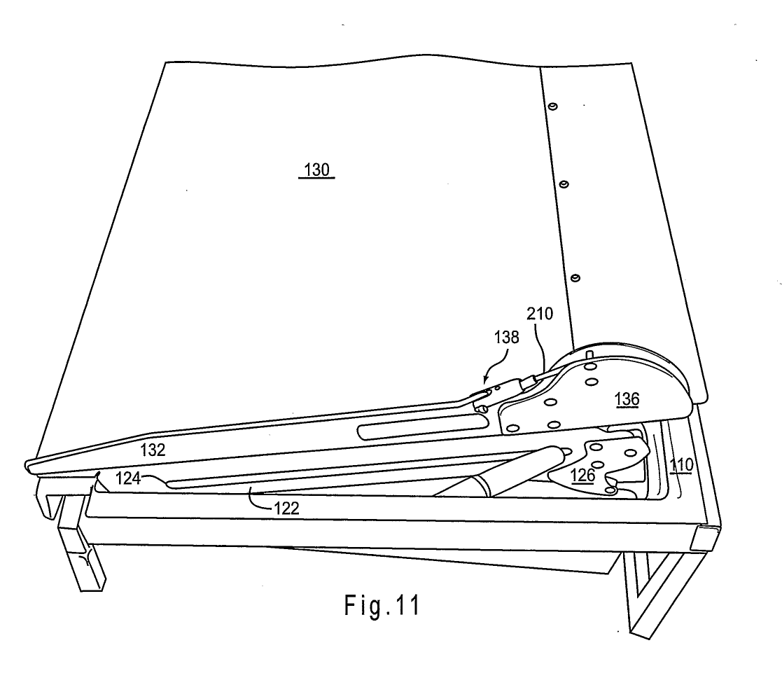

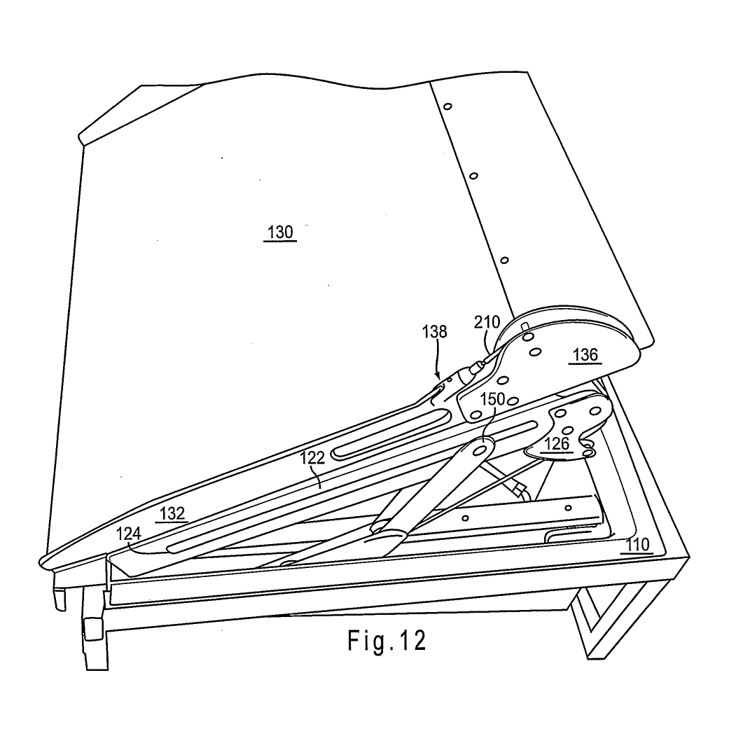

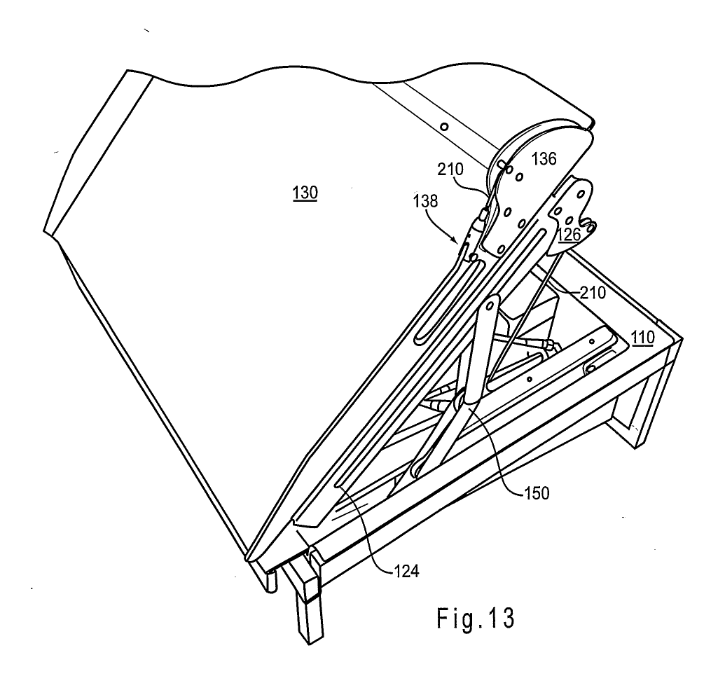

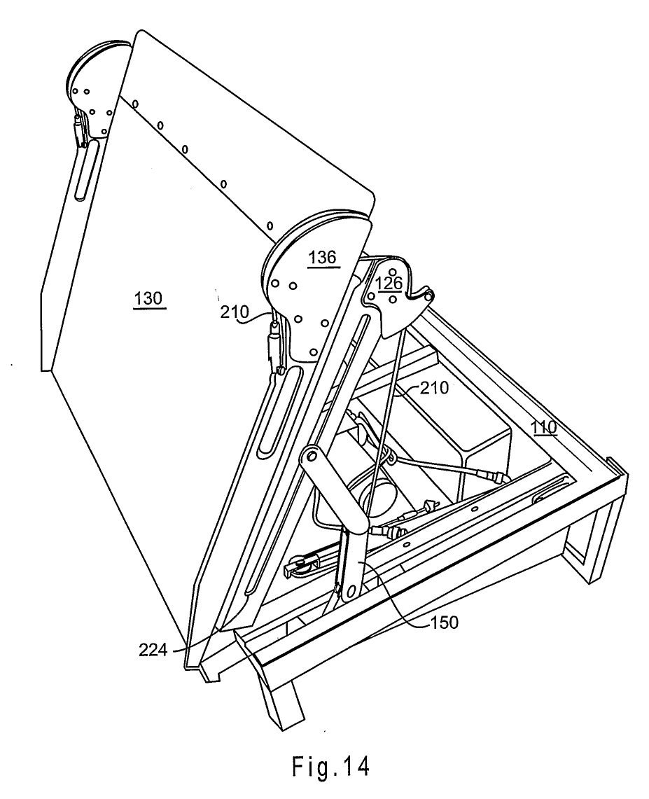

As shown in FIG. 1, the ramp sections 120, 130 include side barriers 122, 132, respectively, for preventing a ramp user from falling off the right or left sides of the deployed ramp. The side barrier 122 of the inboard ramp section 120 includes an elongated slot 124 substantially along the entire length of the barrier 122. The outboard end of the drive member 150 includes a pin, roller, rod, bar or the like that is held captive in the slot 124 for coupling the drive system 140 to the ramp. Further, as can be appreciated from viewing FIGS. 11-18 in succession, the pin, roller, rod, bar or the like at the outboard end of the drive member 150 moves linearly back and forth within the slot 124 to move the ramp sections 120, 130 as the drive system 140 pivots the drive member 150. As shown in FIGS. 11-16, the barrier 122 includes a guide 126 proximate the outboard edge of the barrier 122 and an indent 128 proximate the inboard end of the barrier 122. The indent 128 is sized, shaped and positioned to cooperatively mate with the drive member 150 so that the ramp sections 120, 130 may fold substantially flat on the enclosure 110. FIG. 1 illustrates that when the ramp is fully deployed, the outboard end of the drive member 150 is located at the inboard end of the slot. Further, as can be appreciated from FIG. 11, when the ramp is fully stowed, the outboard end of the drive member 150 is located at the outboard end of the slot 124 (i.e., proximate the guide 126).

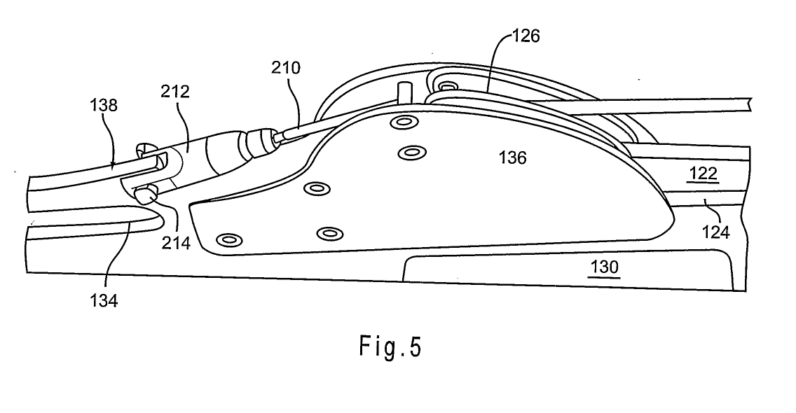

As shown in FIG. 1, the side barriers 132 on the outboard ramp section 130 may each include a handhole 134 or another grasping point to facilitate manual operation of the ramp such as during a malfunction or loss of power to the drive system 140. As shown, the handhole 134 is located proximate the inboard edge of the platform section 130, but the handhole 134 may be located elsewhere, for example at the outboard end of the section 130 or on a portion of the side barrier 122 of the inboard ramp section 120. Inboard from the handhole 134 are a guide 136 and an attachment point 138 to be discussed in further detail hereafter. As best illustrated in FIG. 5, the cable guides 126, 136 are sized and shaped to mate with each other as the ramp is deployed.

As described, one will understand that the drive system 140 is coupled with the inboard ramp section 120 to pivot the section 120 for deploying and stowing the ramp. Although the outboard ramp section 130 is movably coupled with the inboard ramp section 120 (e.g., as illustrated, the sections 120, 130 of the exemplary embodiment are hingedly coupled) to ultimately provide a continuous ramp, the outboard ramp section 130 is not directly coupled to the drive system 140. As such, the outboard ramp section 130 generally moves under the influence of gravity and a tension force described hereafter. A dynamic system, independent from the drive system 140, provides the tension force to oppose the force of gravity and facilitate the folding and unfolding of the outboard ramp section 130 relative to the orientation of the inboard ramp section 120.

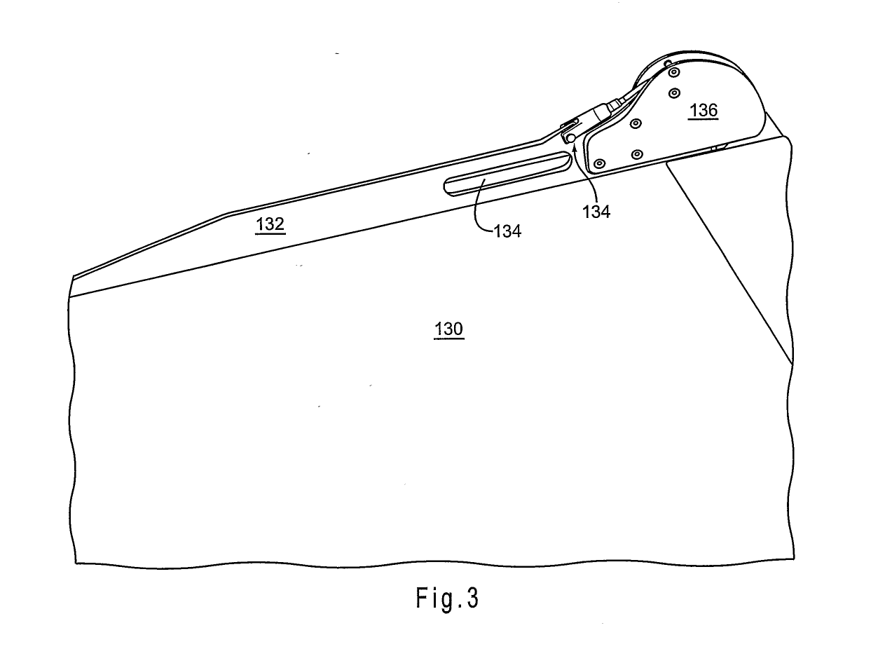

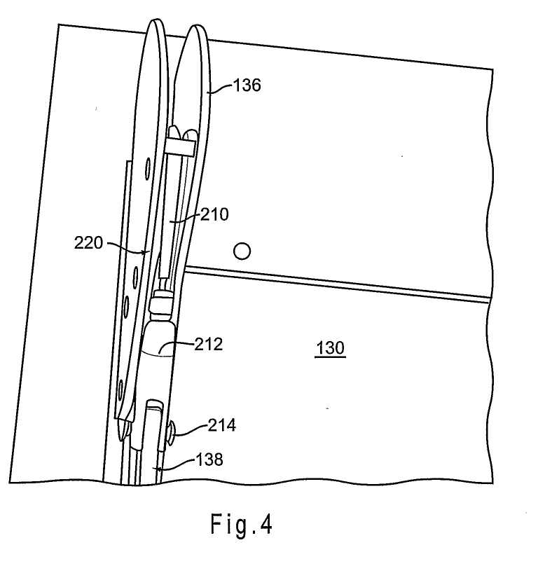

Referring now to FIGS. 3-10 the dynamic system 200 of the ramp system 100 will be described. The dynamic system 200 includes a tension member 250 cooperating with a flexible member 210 having a fixed length wherein one end of the flexible member 210 is coupled to the enclosure 110 and the other end of the flexible member 210 is coupled to the outboard ramp section 130. The flexible member 210 may be a cable, although the flexible member 210 alternatively may be a chain, wire, rope, band, belt or the like. Preferably, the flexible member 210 is a braided metal cable and jacketed to inhibit fraying of the cable, but the flexible member 210 may be a solid malleable form of cable or an otherwise durable and bendable material. As shown in FIGS. 3-5, a first end of the flexible member 210 is coupled to the side barrier 132 of the outboard ramp section 130. As shown, a connector 212 is affixed to a first end 220 of the flexible member 210. The connector 212 includes a split end with a hole therethrough for accepting a fastener 214 such as a pin, screw, bolt or the like to attach the connector 212 to the attachment point 138 on the side barrier 132. As illustrated in FIG. 3, the connector 212 is angled upward slightly with respect to the surface of the outboard ramp section 130. When a tension force is applied to the flexible member 210, the tension force is applied to the outboard ramp section 130 and may be resolved to have an inboard component and a vertical component that opposes the force of gravity. As shown in FIGS. 4 and 5, the guides 126, 136 provide a path for the flexible member 210 to pass across the hinge or pivot point of the inboard ramp section 120 and the outboard ramp section 130. The guide 126 on the inboard ramp section is sized and positioned to fit within the guide 136 on the outboard ramp section 130 when the ramp sections 120, 130 form a unified ramp. The guides 126, 136 may include pins, pulleys, passages or the like about or through which the flexible member 210 extends to prevent the flexible member 210 from becoming accidentally disengaged from the ramp sections 120, 130 or caught between the sections 120, 130 during the deployment and stowing of the ramp.

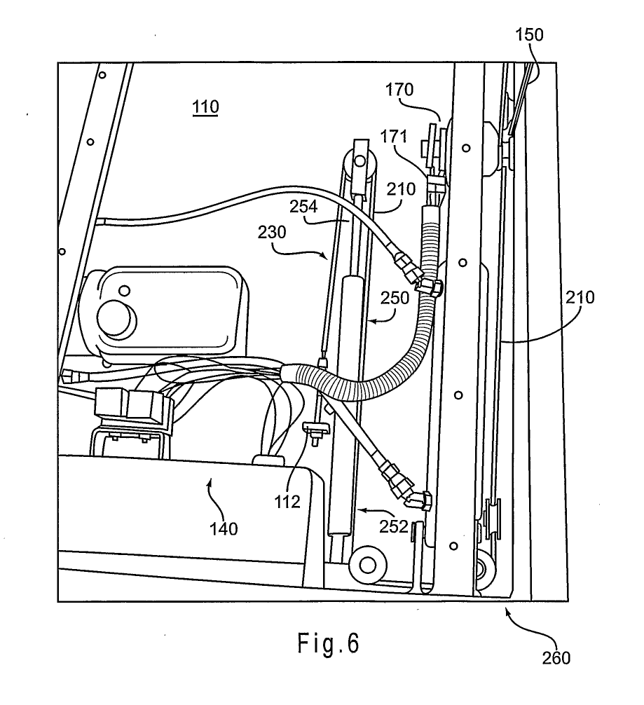

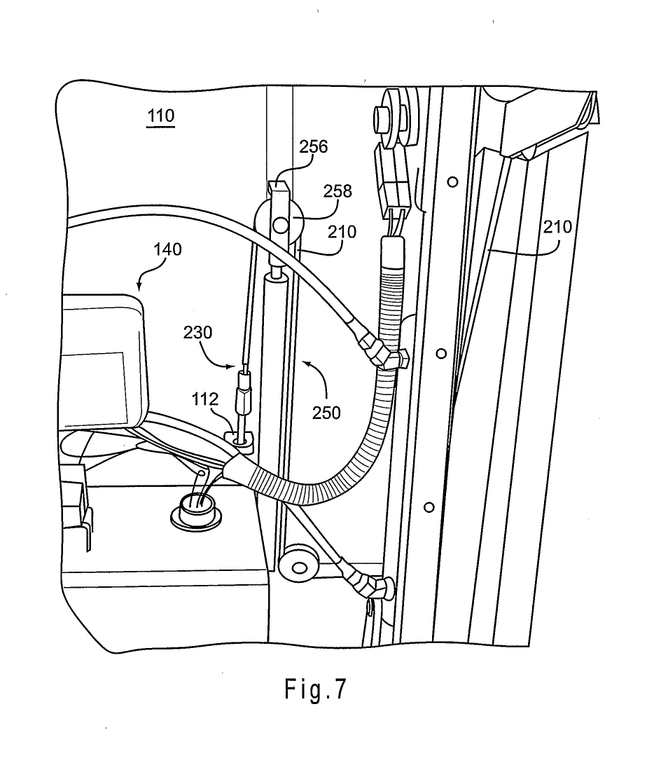

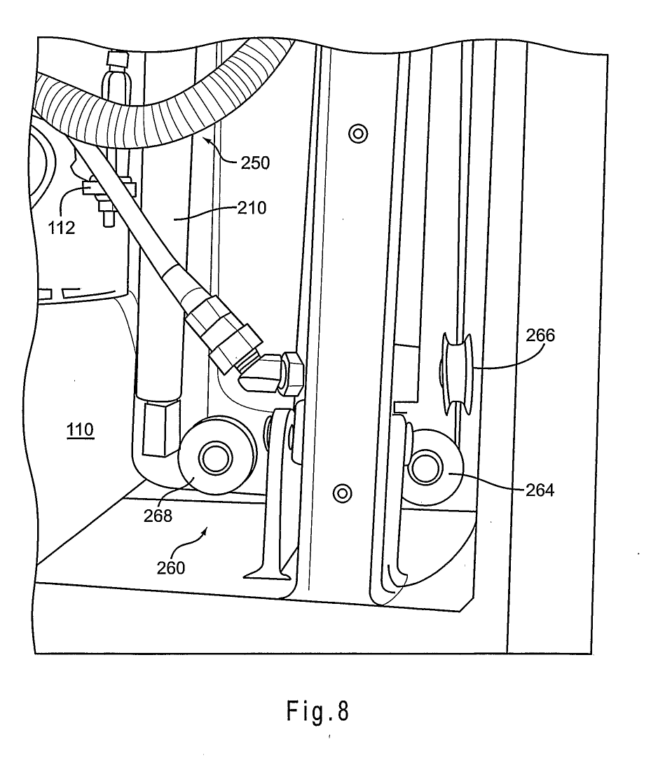

As shown in FIG. 6 the second end 230 of the flexible member 210 is fixedly coupled to an anchor 112 that is welded or otherwise permanently attached to the enclosure 110. As illustrated, the anchor 112 may be located on the floor of the pan. A tension member 250 is disposed proximate to and alongside the anchor 112 such that the tension member 250 is oriented generally parallel to the centerline of the enclosure 110. The tension member 250 may be a spring or spring-biased compressible member known in the art. As illustrated, an embodiment of the tension member 250 may be a gas spring with a fixed cylinder 252 and a movable rod 254 that may be biased in an outboard direction. As illustrated in FIG. 8, the cylinder 252 may be fixedly coupled at its piston end to the pan proximate the inboard wall thereof so that the rod 254 may move inboardly and outboardly. As shown in FIG. 7, the tension guide 256 includes a first pulley 258 that is coupled to the end of the rod 254. The tension guide 256 may prevent the flexible member 210 from accidentally disengaging from the first pulley 258. The tension member 250 cooperates with the flexible member 210 by applying a tension to the flexible member 210 throughout the operation of the ramp. The flexible member 210 first extends outboardly from the anchor 112, and is threaded through the guide 256 around the first pulley 258 so that the flexible member 210 is directed inboardly making a U-shape about the tension member 250. Continuing from the first pulley 258, the flexible member 210 is directed around the linear actuator of the drive system 140 by a horizontal pulley arrangement 260 as shown in FIGS. 6 and 8.

As shown in FIG. 8, the pulley arrangement 260 includes two horizontal pulleys 262, 264 that are in-line and proximate to the inboard wall of the pan. A vertical pulley 266 is proximate to the side wall of the pan and in-line with the drive member 150. The perimeters of the horizontal pulleys 262, 264 are substantially close to the inboard wall of the pan to prevent the flexible member 210 from disengaging from the pulleys 262, 264. The pulleys 258, 262, 264, 266 may be fixed or rotatable on their posts to reduce wear (e.g., abrasion) to the flexible member 210.

As illustrated in FIG. 6, the flexible member 210 may extend in a zigzag manner about the tension member 250 and pulley arrangement 260 from the anchor 112 to the drive member 150. As previously mentioned, the drive member 150 includes guides 154, 156. The flexible member 210 may be disposed on the underside of the vertical pulley 266 and extends therefrom to extend between the guides 154, 156. The flexible member 210 extends towards the outer ramp section 130 under the bottom of guide 154 and over the top of guide 156 as shown in FIG. 9. The guides 154, 156 also may be fixed or rotatable to reduce wear on the flexible member 210. The guides 154, 156 direct the flexible member 210 from the drive member 150 to the guides 126, 136 on ramp sections 120, 130 respectively, and towards the attachment point 138 on the outboard ramp section 130.

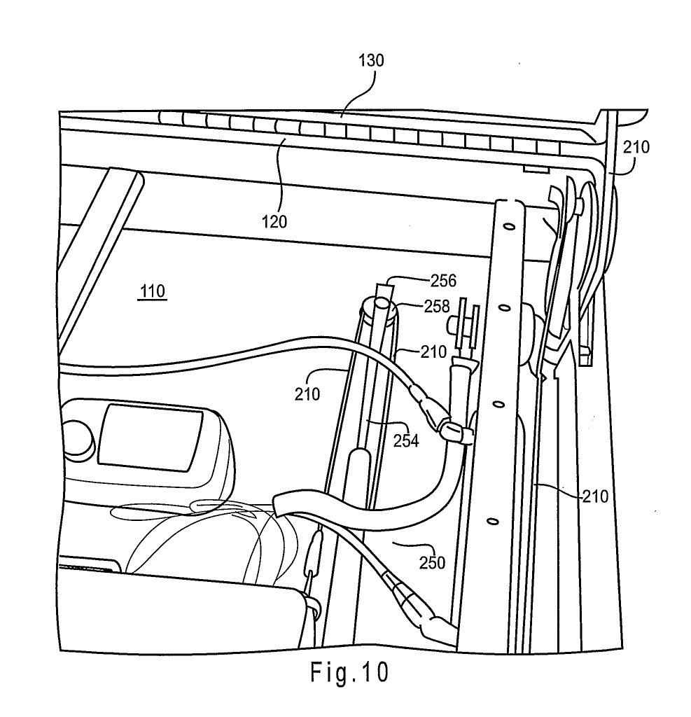

The fixed length flexible member 210 is tension-coupled with the outboard ramp section 130. As illustrated in FIGS. 6, 7 and 10, the rod 254 of the tension member 250 moves inboardly (i.e., is compressed) as the ramp is deployed. As the ramp deploys, the distance between the anchor 112 and the attachment point 138 increases. As the flexible member 210 stretches, it applies a compression force on the tension member 250. The tension member 250 keeps the flexible member 210 relatively taunt. As shown in FIG. 10, the ramp is in an initial state prior to deployment. The rod 254 is almost fully extended and the ramp sections 120, 130 are folded such that the attachment point 138 is proximate to the anchor 112. In FIG. 6, the ramp is partially deployed and the rod 254 is partially compressed inboardly as the attachment point 138 of the outboard ramp section 130 moves away from the anchor 112. In FIG. 7, the rod 254 is fully compressed as the ramp is fully deployed. As shown in this embodiment, the attachment point 138 is at its maximum distance from the anchor 112. Thus, the rod 254 moves in response to the pivoting of the drive member 150 that moves the ramp sections 120, 130.

In FIG. 11 the ramp is in the early stages of deploying from the fully stowed state illustrated in FIG. 2. Viewing FIGS. 11-18 sequentially, the ramp advances from the stored position to full deployment. In FIG. 11, the ramp is folded and stowed compactly with the ramp sections 120, 130 “back to back” so that the bottom surfaces or undersides of the ramp sections 120, 130 are in contact. As shown in FIGS. 11-14, the inboard ramp section 120 is pivoted upward and outward by the drive member 150. The outboard ramp section 130 maintains contact against the inboard ramp section 120 by gravity during movement to about the vertical position, the flexible member 210 exerts and maintains a tension force to the attachment point on the inboard side of the outboard section 130. The vertical component of the tension force is insufficient during this stage of deployment to oppose the gravitational moment on the outboard section 130 so that the outboard section 130 remains against the inboard section 120.

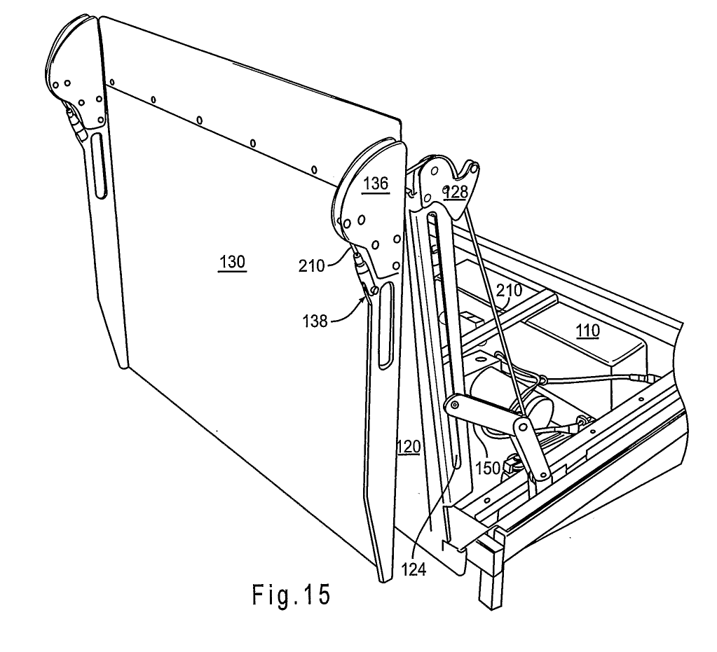

As the inboard ramp section 120 is moved by the drive member 150 to a generally vertical orientation as shown in FIG. 15, the outboard ramp section 130 begins to pivot away from the inboard ramp section 120 about the hinge coupling between the inboard ramp section 120 and the outboard ramp section 130. A tension force exerted by the flexible member 210 onto the inboard end of the outboard ramp section 130 is resolved into a vertical component and an outboard component causing the outboard ramp section 130 to pivot slightly about the hinge coupling between the sections 120, 130 as the sections move beyond the generally vertical position. Thus, the flexible member 210 in cooperation with the tension member 250 facilitates the deployment of the outboard ramp section 130 to a fully extended position. The ramp may fully deploy under gravity power (known as “gravity down”) after the ramp sections 120, 130 pass the vertical point illustrated in FIG. 15. Thus, the ramp drive system 140 may turn off to conserve vehicle power and reduce wear and tear on a hydraulic power unit or actuator which may extend the operating life of the ramp system 100.

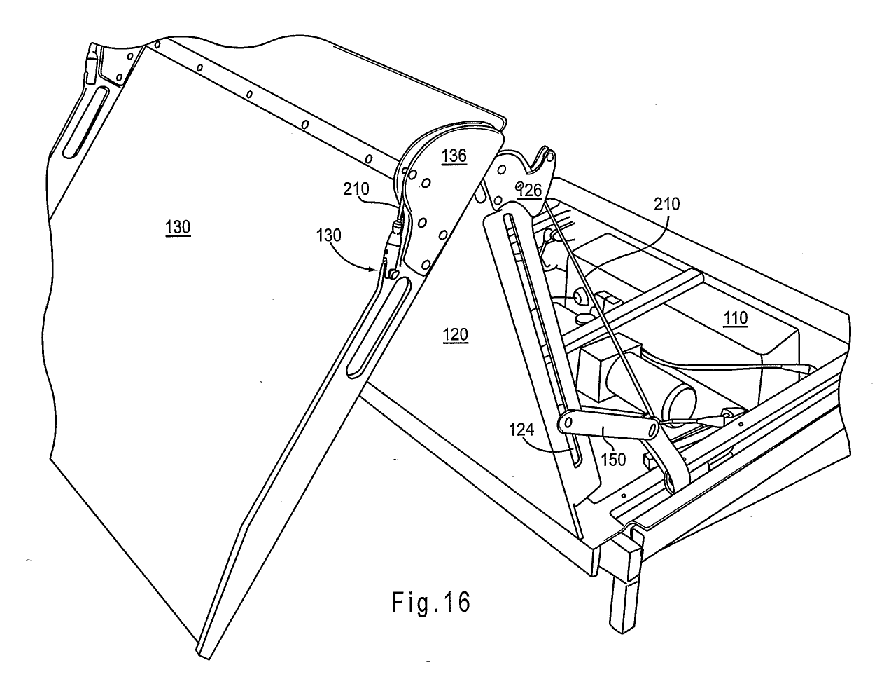

As shown in FIG. 16, the ramp sections 120, 130 continue to deploy as the inboard ramp section 120 rotates about the hinge coupling between the inboard ramp section 120 and the enclosure 110. As the inboard ramp section 120 rotates, the attachment point 138 on the outboard ramp section 130 moves farther away from the anchor 112 and the flexible member 210 is further tensioned. The tension force exerted by the flexible member 210 on the inboard end of the outboard ramp section 130 is now resolved to have an upward vertical component and an inboard component, the vertical component opposing and overcoming the gravitational force on the outboard ramp section 130 so that the outboard ramp section 130 is pivoted about the hinge coupling between the ramp sections 120, 130.

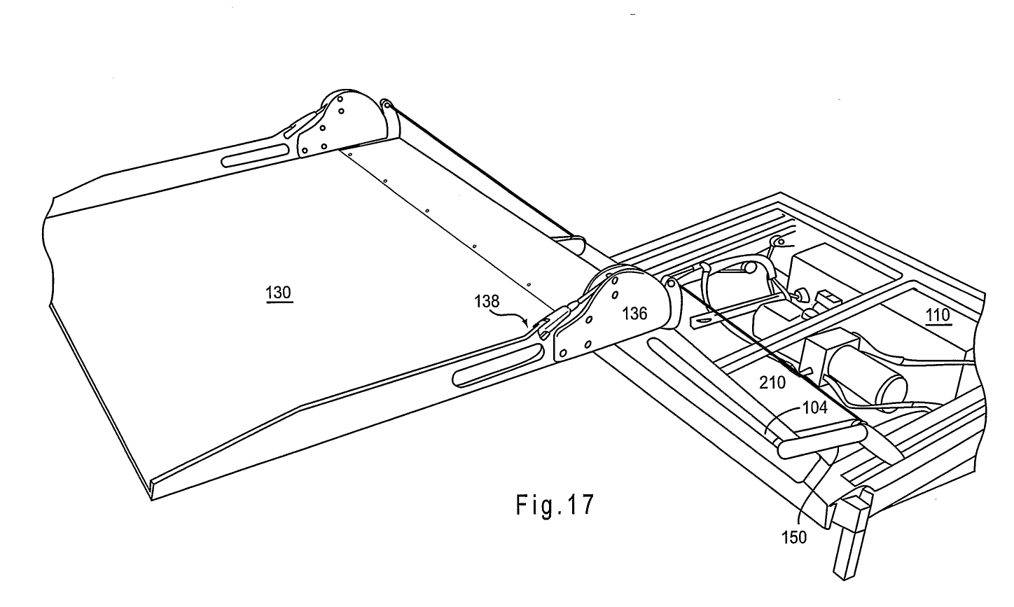

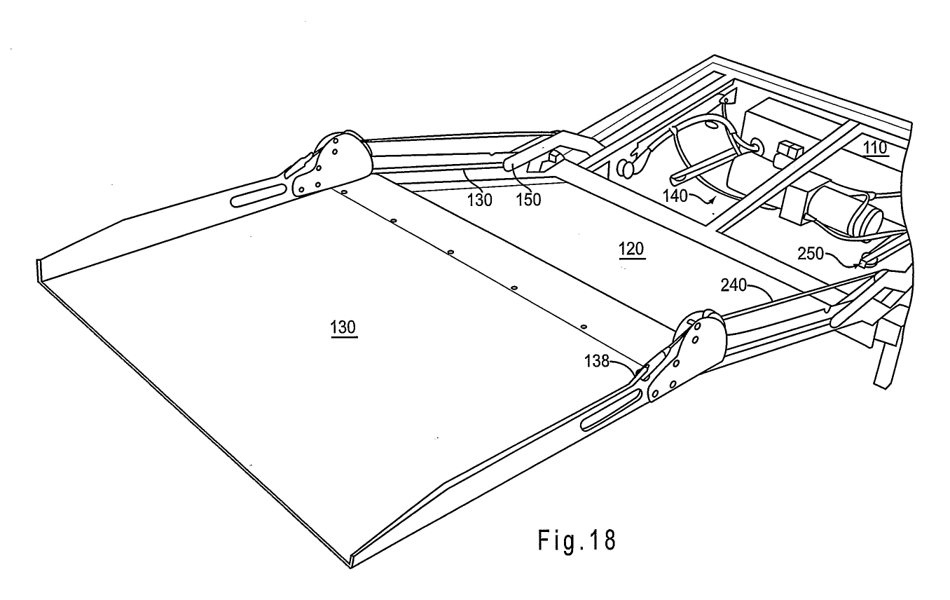

Continuing rotation of the inboard ramp section 120 increases the distance between the attachment point 138 on the outboard ramp section 130 and the anchor 112 thereby increasing the tension of the flexible member 210. As shown in FIG. 17, the tension force exerted by the flexible member 210 on the inboard end of the outboard ramp section 130 is now resolved to have an upward vertical component that substantially overcomes the gravitational force on the outboard ramp section 130 and the outboard ramp section 130 becomes generally horizontal. As shown in FIGS. 18 and 1, the inboard ramp section 120 continues to rotate until the drive member 150 comes to rest at the inboard end of the slot 122 and the inboard ramp section 120 is angled downward with respect to the enclosure 110. As the inboard ramp section 120 continues to rotate, the distance between the attachment point 138 on the outboard ramp section 130 and the anchor 112 increases further, thereby increasing the tension of the flexible member 210. The outboard end of the outboard ramp section 130 becomes angled slightly upward (see FIG. 18) due to the increased vertical component of the tension force and the sections 120, 130 become coplanar before the inboard ramp section 120 has stopped rotating.

In reverse operation (i.e., ramp stowage from the fully deployed orientation of FIG. 1) the tension force exerted by the flexible member 210 on the outboard ramp section 130 prevents the outboard end of the outboard ramp section 130 from dragging on the ground. As the inboard ramp section 120 rotates upward and inward the distance between the attachment point 138 and the anchor 112 decreases and the tension force on the outboard ramp section 130 decreases so that the gravitational force on the outboard ramp section 130 overcomes the tension force's vertical component. The gravitational force on outboard ramp section 130 thereby folds or pivots the outboard ramp section 130 toward the inboard ramp section 120. During stowage as the sections 120, 130 pass through a generally vertical orientation (FIG. 15), the tension force horizontal (i.e., outboard) component prevents the outboard ramp section 130 from forcefully contacting the inboard ramp section 120 in connection with the inward pivoting movement of the inboard ramp section 120. Further, as previously described with respect to the deployment operation of the ramp, the ramp may gravity down to fully stow the ramp sections 120, 130 after passing through the orientation illustrated in FIG. 15.

To provide the foregoing described “gravity down” deployment and stowage of the ramp, the system 100 may include one or more switches, sensors or the like for detecting the orientation of at least one of the ramp sections 120, 130. As best illustrated in FIG. 6, a cam arrangement 170 is located on an end of the shaft that pivots the drive member 150. Proximate the cam arrangement 170 are switches 171 such as contact microswitches or the like that are actuated by the cams in response to movement of the drive member 150. A first switch may be operable to turn off the drive system 140 when the ramp is substantially vertical during deployment, whereas a second switch may be operable to turn off the drive system 140 when the ramp is substantially vertical during stowage, or vice versa. First and second cams are operable to actuate the first and second switches, or second and first switches, respectively. The sensors or switches may be “hard wired” to a hydraulic power unit or electric actuator, or alternatively they may be linked to a controller, which may be a programmable logic controller, microprocessor controller, or the like, so that the drive system 140 may be shut off when respective sensors are actuated during deployment and stowage so the ramp may gravity-down.

Exemplary embodiments of this invention are described herein. Variations of those embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1: A ramp system comprising:
a mounting enclosure;
a ramp having an inboard section pivotally coupled to the mounting enclosure and an outboard section pivotally coupled to the inboard section;
a drive system that moves the ramp between stowed and deployed positions;
a flexible member connected between a fixed point in the mounting enclosure and a fixed point on the outboard ramp section for controlling the movement of the outboard ramp section when the ramp moves between the stowed and deployed positions; and
a tensioning member disposed in the mounting enclosure independently of the drive system for applying a tension force to the flexible member when the ramp moves between the stowed and deployed positions.

2: The ramp system of claim 1, wherein the tensioning member maintains the flexible member taut when the ramp moves between the stowed and deployed positions.

3: The ramp system of claim 1, wherein the tensioning member comprises a gas spring.

4: The ramp system of claim 1, wherein extension and retraction of the tensioning member controls the tension in the flexible member when the ramp moves between the stowed and deployed positions.

5: The ramp system of claim 1, wherein the flexible member extends around at least a portion of the tensioning member.

6: (canceled)

7: (canceled)

8: A ramp system that provides ingress and egress to a vehicle, the ramp system comprising:
a two-part ramp having an inboard section pivotally coupled to the vehicle and an outboard section pivotally coupled to the inboard section;
a drive system that moves the ramp between a folded position within the vehicle and an extended position outside the vehicle;
a flexible member connected between a fixed point inside the vehicle independent of the drive system and a fixed point on the outboard ramp section for controlling the movement of the outboard ramp section when the ramp moves between the folded and extended positions; and
a tension member that provides tension to the flexible member when the ramp moves between the folded and extended positions.

9: The ramp system of claim 8, wherein the tension member is disposed inside the vehicle.

10: The ramp system of claim 8, wherein the outboard ramp section folds on top of the inboard ramp section when the ramp is in the folded position.

11: The ramp system of claim 8, wherein the tension member comprises a gas spring.

12: The ramp system of claim 8, wherein extension and retraction of the tension member controls the tension in the flexible member when the ramp moves between the folded and extended position.

13: (canceled)

14: The ramp system of claim 8, wherein the flexible member is a cable.

15: A system for facilitating the deployment and stowing of a ramp that provides ingress and egress to a vehicle or other structure, wherein the ramp includes an inboard and outboard section pivotally coupled to one another, the system comprising:
a flexible member having an end connected to a fixed point on the vehicle or other structure and an opposite end connected to the outboard ramp section for controlling the movement of the outboard ramp section when the ramp moves between the stowed and deployed positions; and
a tensioning member disposed in the vehicle or other structure and engaging the flexible member to apply a tension force to the flexible member when the ramp moves between the stowed and deployed positions.

16: The ramp system of claim 15, wherein extension and retraction of the tensioning member controls the tension in the flexible member when the ramp moves between the stowed and deployed positions.

17: (canceled)

18: The ramp system of claim 15, wherein the tensioning member comprises a gas spring.
